(19) United States
(12) Patent Application Publication
(10) Pub. No.: US 2018/0373233 A1
(43) Pub. Date: Dec. 27, 2018

(54) FAILURE PREDICTING APPARATUS AND MACHINE LEARNING DEVICE

(71) Applicant: FANUC Corporation, Yamanashi (JP)

(72) Inventor: Kazuya GOTO, Yamanashi (JP)

(21) Appl. No.: 16/012,803

(22) Filed: Jun. 20, 2018

(30) Foreign Application Priority Data
Jun. 27, 2017 (JP) 2017-125598

(51) Int. Cl. G05B 23/02; G06F 15/18; G06F 11/30

(52) U.S. Cl. CPC G05B 23/0283; G05B 23/024; G05B 23/0254; G05B 17/02; G06F 11/3058; G06F 11/3051; G06F 15/18

(57) ABSTRACT

A machine learning device included in a failure predicting apparatus includes a state observing unit that observes, as state variables indicating a current environmental state, operating state data indicating an operating state of the management target device and device configuration data indicating a device configuration of the management target device, a label data acquiring unit that acquires, as label data, maintenance history data indicating a maintenance history of the management target device, and a learning unit that, by using the state variables and the label data, learns a failure timing of a printed circuit board included in the management target device, the operating state data, and the device configuration data such that the failure timing is associated with the operating state data and the device configuration data.

### BACKGROUND OF THE INVENTION

### Field of the Invention

The present invention relates to a failure predicting apparatus and a machine learning device, and more particularly, to a control apparatus and a machine learning device for predicting a failure of a printed circuit board or a component included in a numerical controller.

### Description of the Related Art

In order to avoid reduction in productivity due to a failure in a machine such as a numerical controller or a machine tool, maintenance of the machine has been strongly demanded to be carried out before occurrence of a failure. Such advance maintenance is typically carried out as a regular inspection on a predetermined date. Also, a technology has been recently proposed which, by using information about a failure that occurred in a certain device, predicts the possibility of occurrence of a similar failure in a device of the same type.

As a conventional technology pertaining to prediction of a machine failure, a technology of diagnosing the lifetime of a machine tool by learning using a neural network is disclosed in Japanese Patent Laid-Open No. 2002-090266, for example. In addition, a technology of estimating the lifetime of a CNC mechanical element by integration of disturbance load torque is disclosed in Japanese Patent Laid-Open No. 07-051993.

In a general production line in which a machine tool having a numerical controller incorporated therein is used, the production line is greatly influenced by a sudden failure of the device. For this reason, in order to maintain a high operation rate of the line, highly precise lifetime prediction is required while the operation environment of the tool is taken into consideration. However, in each of the technologies disclosed in Japanese Patent Laid-Open No. 2002-090266 and Japanese Patent Laid-Open No. 07-051993, prediction of a failure is performed according to a specific estimation model. The prediction of a failure is not performed while various environmental factors under which the machine tool operates are taken into consideration. Accordingly, these technologies have a problem that, when a failure occurs in an unanticipated mode, prediction of a failure cannot be performed with high precision.

Moreover, when a maintenance work is carried out on a tool, which printed board (a main board, a CPU card, or a servo card, etc.) included in the tool is to be subjected to the work needs to be determined. However, each of the technologies disclosed in Japanese Patent Laid-Open No. 2002-090266 and Japanese Patent Laid-Open No. 07-051993 does not output which printed circuit board or which component included in the tool is predicted to fail with respect to environmental factors under which the tool operates, and thus, these technologies are not considered to be useful to reduce the maintenance working time or the cost for the maintenance.

### SUMMARY OF THE INVENTION

Therefore, an object of the present invention is to provide a failure predicting apparatus and a machine learning device which are capable of performing highly precise prediction of a failure in each of printed circuit boards or components included in a tool.

By machine learning of the correlation between information concerning the environment where a tool operates and a failure of a printed circuit board or a component included in the tool, the failure predicting apparatus according to the present invention solves the aforementioned problems.

One aspect of the present invention is a failure predicting apparatus for predicting a failure timing of a printed circuit board included in a management target device, the failure predicting apparatus comprising a machine learning device that learns the failure timing of the printed circuit board included in the management target device, with respect to an operating state of the management target device, wherein the machine learning device includes a state observing unit that observes, as state variables indicating a current environmental state, operating state data indicating an operating state of the management target device and device configuration data indicating a device configuration of the management target device, a label data acquiring unit that acquires, as label data, maintenance history data indicating a maintenance history of the management target device, and a learning unit that, by using the state variables and the label data, learns the failure timing of the printed circuit board included in the management target device, the operating state data, and the device configuration data such that the failure timing is associated with the operating state data and the device configuration data.

Another aspect of the present invention is a machine learning device for learning a failure timing of a printed circuit board included in a management target device with respect to an operating state of the management target device, the machine learning device comprising a state observing unit that observes, as state variables indicating a current environmental state, operating state data indicating an operating state of the management target device and device configuration data indicating a device configuration of the management target device, a label data acquiring unit that acquires, as label data, maintenance history data indicating a maintenance history of the management target device, and a learning unit that, by using the state variables and the label data, learns the failure timing of the printed circuit board included in the management target device, the operating state data, and the device configuration data such that the failure timing is associated with the operating state data and the device configuration data.

In the failure predicting apparatus of the present invention, a failure estimating model is updated at any time by machine learning so that highly precise prediction of a failure can be performed. In addition, in the failure predicting apparatus of the present invention, since prediction of a failure is performed on a printed circuit board/component basis, the maintenance working time and the cost for the maintenance can be reduced.

### BRIEF DESCRIPTION OF THE DRAWINGS

The aforementioned object, other objects, and the features of the present invention will be made clear from the following explanation of embodiments with reference to the accompanying drawings, wherein:

FIG. 1 is a schematic hardware configuration diagram of a control apparatus according to a first embodiment;

FIG. 2 is a schematic functional block diagram of the control apparatus according to the first embodiment;

FIG. 3 is a diagram illustrating an example of state variables S and label data L acquired by a failure predicting apparatus according to the first embodiment;

FIG. 4 is a diagram illustrating an example in which a learning unit performs machine learning by using the state variables S and the label data L;

FIG. 5 is a schematic functional block diagram illustrating one embodiment of the control apparatus;

FIG. 6A is a diagram illustrating neurons;

FIG. 6B is a diagram illustrating a neural network; and

FIG. 7 is a schematic functional block diagram of a control apparatus according to a second embodiment.

### DETAILED DESCRIPTION OF THE PREFERRED EMBODIMENTS

Hereinafter, embodiments of the present invention are described with reference to the drawings.

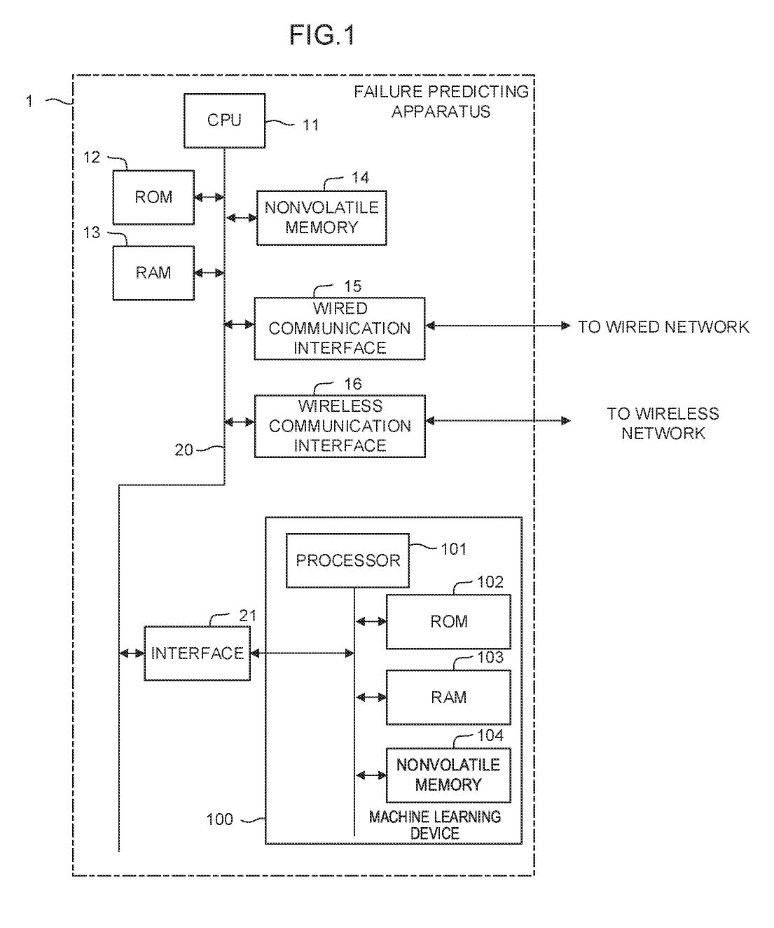

FIG. 1 is a schematic hardware configuration diagram illustrating the main part of a failure predicting apparatus according to a first embodiment and the main part of a machining tool to be controlled by the failure predicting apparatus. A failure predicting apparatus 1 can be implemented as a higher level apparatus (e.g., a host computer, or a cell controller) for managing a management target device, such as a control apparatus (not illustrated) for controlling a plurality of machine tools (not illustrated) located at a site such as a factory, a controller (not illustrated) for controlling a robot (not illustrated), or the like. A CPU 11 included in the failure predicting apparatus 1 according to the present embodiment is a processor that performs overall control of the failure predicting apparatus 1. The CPU 11 reads out, via a bus 20, a system program stored in a ROM 12, and performs overall control of the failure predicting apparatus 1 in accordance with the system program. Temporal calculation data and display data are temporarily stored in a RAM 13.

A nonvolatile memory 14 is configured as a memory in which the storage state thereof is held by, for example, being backed up with use of a battery (not illustrated) even when the power of the failure predicting apparatus 1 is turned off. In the nonvolatile memory 14, data inputted via an input device (not illustrated) such as a keyboard, an operation program inputted via an interface (not illustrated), management data concerning a management target device (the type, configuration, network address, and current set position, etc. of the management target device) are stored. The program and various types of data stored in the nonvolatile memory 14 may be developed in the RAM 13 when being executed or used. Also, various system programs (including a system program for controlling communication with a machine learning device 100 (described later)) for executing commands to the management target device are written in advance in the ROM 12.

The failure predicting apparatus 1 is configured to be able to exchange a command or data with the management target device through wired or wireless communication via a wired communication interface 15 or a wireless communication interface 16. These communication interfaces may use any communication protocol as long as exchange of a command or data with the management target device can be performed.

An interface 21 is for connecting the failure predicting apparatus 1 and the machine learning device 100 to each other. The machine learning device 100 includes a processor 101 which performs overall control of the machine learning device 100, a ROM 102 in which a system program, etc. is stored, a RAM 103 for temporal storing during processes related to machine learning, and a nonvolatile memory 104 which is used to store a learning model, etc. The machine learning device 100 is able to observe various types of information (e.g., the operating state of the management target device) which can be acquired by the failure predicting apparatus 1 via the interface 21.

Furthermore, in response to the prediction result of a failure in printed circuit boards or components, etc. included in the management target device outputted from the machine learning device 100, the failure predicting apparatus 1 gives, via the wired communication interface 15 or the wireless communication interface 16, a command for prompting countermeasures to the prediction result of a failure.

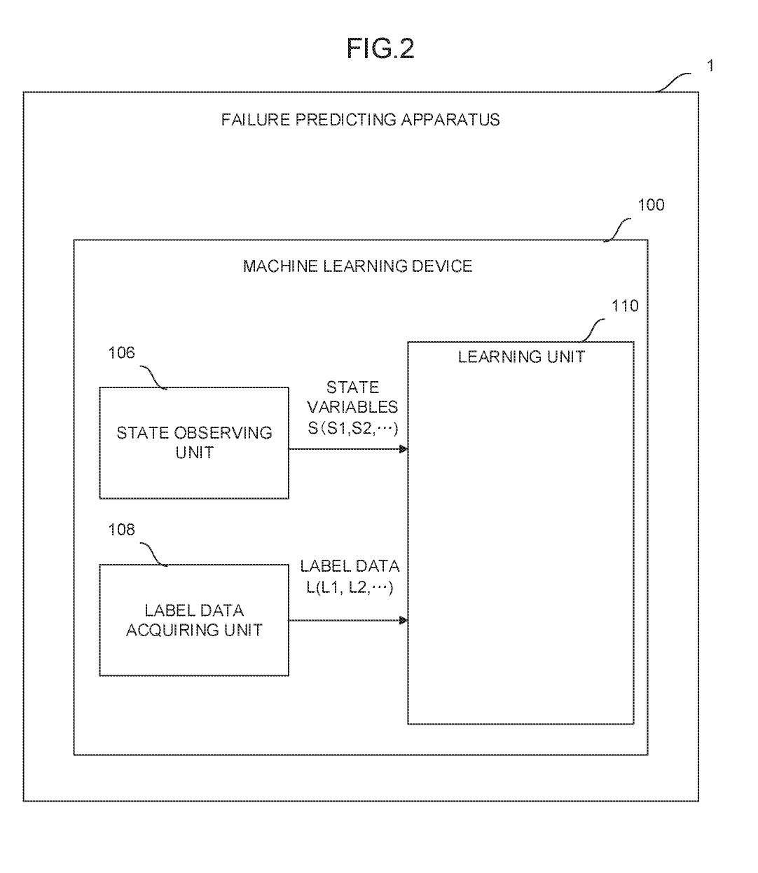

FIG. 2 is a schematic functional block diagram of the failure predicting apparatus 1 and the machine learning device 100 according to the first embodiment. The machine learning device 100 includes software (e.g., a learning algorithm) and hardware (e.g., the processor 101) for learning, by itself and by so-called machine learning, a failure timing (when and in which printed circuit board and which component a failure will occur) of a printed circuit board and a component included in the management target device with respect to the operation environment of the management target device. The machine learning device 100 included in the failure predicting apparatus 1 learns what corresponding to a model structure indicating the correlation between the operating environment of the management target device and the failure timing (when and in which printed circuit board and which component a failure will occur) of the printed circuit board and the component included in the management target device.

As illustrated by use of functional blocks in FIG. 2, the machine learning device 100 included in the failure predicting apparatus 1 includes a state observing unit 106 that observes state variables S including operating state data S1 indicating the operating state of the management target device and device configuration data S2 indicating the configuration of the management target device, a label data acquiring unit 108 that acquires label data L including maintenance history data L1 indicating a past maintenance history, and a learning unit 110 that learns, by using the state variables S and the label data L, the operating state of the device and the failure timing (when and in which printed circuit board a failure will occur) of the printed circuit board included in the management target device.

The state observing unit 106 may be formed as one function of the processor 101, for example. Alternatively, the state observing unit 106 may be formed as software that is for causing the processor 101 to function and that is stored in the ROM 102, for example. Of the state variables S being observed by the state observing unit 106, the operating state data S1 can be acquired as a set of data indicating the operating state of the management target device. Examples of the operating state data S1 include an accumulated operating time, an accumulated power consumption, an input voltage/current, an output voltage/current, an environmental temperature, an environmental humidity, a vibration, the usage state of a cutting fluid, and the rotation speed of a cooling fan, which are of the management target device. The data such as the accumulated operating time, the accumulated power consumption, the input voltage/current, the output voltage/current, the environmental temperature, the environmental humidity, and the vibration may be acquired for each printed circuit board included in the management target device. The aforementioned data which has been recorded in the management target device by means of a data logger (not illustrated), etc., may be acquired over a wired or wireless communication network and be used as the operating state data S1.

Of the state variables S, the device configuration data S2 can be acquired from management data for the management target device stored in advance in the nonvolatile memory 14, for example. Alternatively, the device configuration data S2 may be acquired from the management target device over a wired or wireless communication network.

The label data acquiring unit 108 may be formed as one function of the processor 101, for example. Alternatively, the label data acquiring unit 108 may be formed as software that is for causing the processor 101 to function and that is stored in the ROM 102, for example. As the maintenance history data L1 included in the label data L acquired by the label data acquiring unit 108, maintenance-related data reported by a worker who performed a maintenance work may be used, for example. Examples of the maintenance history data L1 may include a printed circuit board exchange history (a failure time, or an exchanged printed circuit board, etc.) of the management target device, a failure history of the management target device, and information about whether or not exchange of a printed circuit board improved a failure in the management target device. The label data L acquired by the label data acquiring unit 108 is an index indicating the result of a maintenance work based on the state variables S.

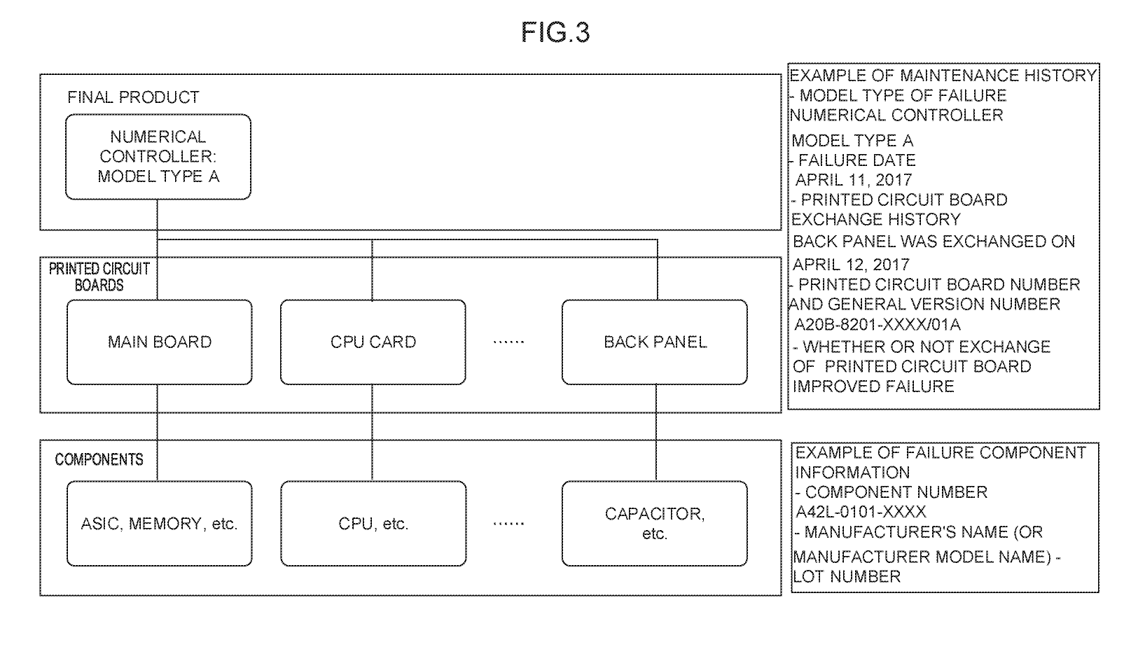

FIG. 3 illustrates examples of the device configuration data S2 and the maintenance history data L1 which are acquired by the failure predicting apparatus 1 of the present embodiment. As illustrated in FIG. 3, the management target device being managed by the failure predicting apparatus 1 includes a plurality of printed circuit boards on which a plurality of components are mounted.

Examples of the printed circuit boards include a main board, a CPU card, a servo card, a GUI card, a back panel, a FROM/SRAM module, various option boards, and an I/O board. Examples of the components mounted on the printed circuit boards include an ASIC (an LSI), a CPU, an IC, a memory, a resistor, a capacitor, a coil, a fan, a battery, and a connector. The device configuration data S2 may include the types of the printed circuit boards, the board numbers of the printed circuit boards, and the general version number of the printed circuit boards, and further may include the component numbers, the manufacturer's names, the lot numbers, and the reference numbers of the components. Examples of the maintenance history data L1 include the model type of a failure printed circuit board, a failure occurrence date of the printed circuit board, a printed circuit board exchange history, the board numbers of the printed circuit board, the general version number of the printed circuit board, and whether or not exchange of the printed circuit board improved a failure.

The learning unit 110 may be formed as one function of the processor 101, for example. Alternatively, the learning unit 110 may be formed as software that is for causing the processor 101 to function and that is stored in the ROM 102, for example. The learning unit 110 learns the label data L with respect to the operating state of the management target device in accordance with arbitrarily defined learning algorithms which are collectively referred to as machine learning. The learning unit 110 can repeatedly perform learning based on a data aggregate including the aforementioned state variables S and the aforementioned label data L.

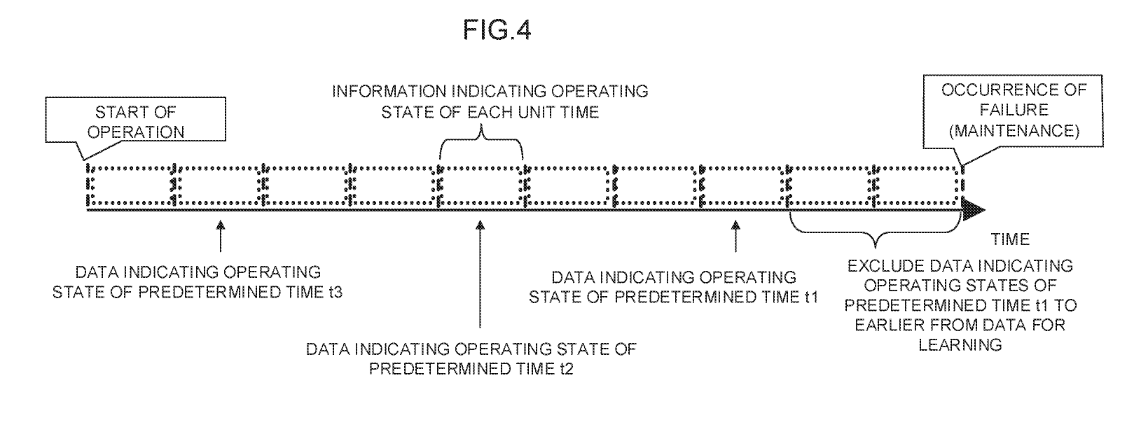

FIG. 4 is a diagram illustrating an example in which the learning unit 110 performs machine learning by using the state variables S and the label data L. When a maintenance work is carried out because of occurrence of a failure in the management target device, the learning unit 110 acquires, as the operating state data S1, information which indicates the operating state recorded prior to the failure by the data logger (not illustrated), etc., included in the management target device, and acquires, as the maintenance history data L1, maintenance-related information inputted by a maintenance worker during the maintenance work. The learning unit 110 extracts, from the operating state data S1 acquired before a time at which the maintenance work of the management target device is carried out, data sets indicating the operating states at predetermined times t1, t2, t3 . . . before, and predicts that a failure corresponding to the maintenance history data L1 will occur after elapse of the predetermined times t1, t2, t3 . . . , by using, as inputs, the extracted data sets and the device configuration data S2, whereby performs machine learning. In a case where the management target device having a predetermined machine configuration is in a predetermined operation environment, how much time will elapse before occurrence of a failure and in which printed circuit board the failure will occur can be learned by this machine learning. Of the data indicating the operating states at the predetermined times t1, t2, t3 . . . before the maintenance time, values acquired at such time points may be used for data the time points of which are significant such as the accumulated operating time or the accumulated power consumption, and sequential values obtained by sampling, in a predetermined cycle, values detected within predetermined times period prior to the respective time points may be used for data the change of which is significant such as the input voltage/current, the output voltage/current, environmental temperature, the environmental humidity, the vibration, the usage state of cutting fluid, or the rotation speed of a cooling fan.

By repeating such a learning cycle, the learning unit 110 can automatically recognize a feature implying the correlation between the operating state (the operating state data S1) and the machine configuration information (the device configuration data S2) of the management target device and the failure timing of the printed circuit board included in the management target device corresponding to the state. At the start time of the learning algorithm, the correlation between the operating state data S1 and the device configuration data S2 and the failure timing of the printed circuit board included in the management target device is substantially unknown. However, along with progress of the learning, the learning unit 110 gradually recognizes the feature and interprets the correlation.

After interpretation of the correlation between the operating state data S1 and the device configuration data S2 and the failure timing of the printed circuit board included in the management target device reaches a substantially reliable level, learning results repeatedly outputted from the learning unit 110 enable highly precise prediction of a failure timing of a printed circuit board included in the management target device with respect to the current state (i.e., the operating state of the management target device and the configuration information of the device). That is, along with progress of the learning algorithm, the learning unit 110 can be gradually bringing, close to an optimum solution, the correlation between the operating state of the management target device and the configuration information of the device and a prediction, with respect to the state, of a timing around which a failure will occur and in which printed circuit board included in the management target device the failure will occur.

As described above, in the machine learning device 100 included in the failure predicting apparatus 1, the learning unit 110 learns, by using the state variables S observed by the state observing unit 106 and the label data L acquired by the label data acquiring unit 108, the failure timing of the printed circuit board included in the management target device in accordance with the machine learning algorithm. The state variables S include data such as the operating state data S1 and the device configuration data S2, which are less likely influenced by disturbance. The label data L can be acquired from maintenance information inputted by a maintenance worker. Therefore, according to the machine learning device 100 included in the failure predicting apparatus 1, a failure timing of a printed circuit board included in the management target device can be automatically, precisely obtained according to the operating state of the management target device and the configuration information of the device, by use of a learning result by the learning unit 110 while computation or estimation is not involved.

In the case where a failure timing of a printed circuit board included in the management target device can be automatically obtained while computation or estimation is not involved, only the operating state (the operating state data S1) and machine configuration information (the device configuration data S2) of the management target device need to be recognized.

Accordingly, the failure timing (when and in which printed circuit board a failure will occur) of the printed circuit board included in the management target device can be predicted with high precision. Therefore, a maintenance worker who has recognized a printed circuit board which is predicted to fail and a failure timing for occurrence of the failure can efficiently carry out a maintenance work on the management target device.

In one modification of the machine learning device 100 included in the failure predicting apparatus 1, the label data acquiring unit 108 may further acquire, as the label data L, failure component data L2 indicating information about a component, on the printed circuit boards, that has been exchanged due to occurrence of a failure, and may use the failure component data L2 for machine learning at the learning unit 110. The failure component data L2 can be acquired by a maintenance worker analyzing a printed circuit board exchanged during a maintenance work and inputting the analysis result, as failure component information as illustrated in FIG. 3, into the management target device or the failure predicting apparatus 1, etc. The failure component data L2 may include the component number, the manufacturer's name, the manufacturer model name, the lot number, and the printed circuit board reference number of a component in which a failure occurred, and the details of the failure, for example.

According to the above modification, when learning a failure timing of a printed circuit board included in a management target device with respect to the operating state and the machine configuration information of the management target device, the machine learning device 100 also can learn in which component on the printed circuit board a failure will occur.

In another modification of the machine learning device 100 included in the failure predicting apparatus 1, the learning unit 110 may learn a failure timing of a printed circuit board of each of a plurality of management target devices, by using the respective state variables S and the label data L obtained for the management target devices. According to this configuration, since the amount of a data aggregate including the state variables S and the label data L obtained within a certain time period can be increased, more various data aggregates can be used as inputs so that the speed of learning the failure timing of the printed circuit board included in each of the management target devices and the credibility of the learning can be improved.

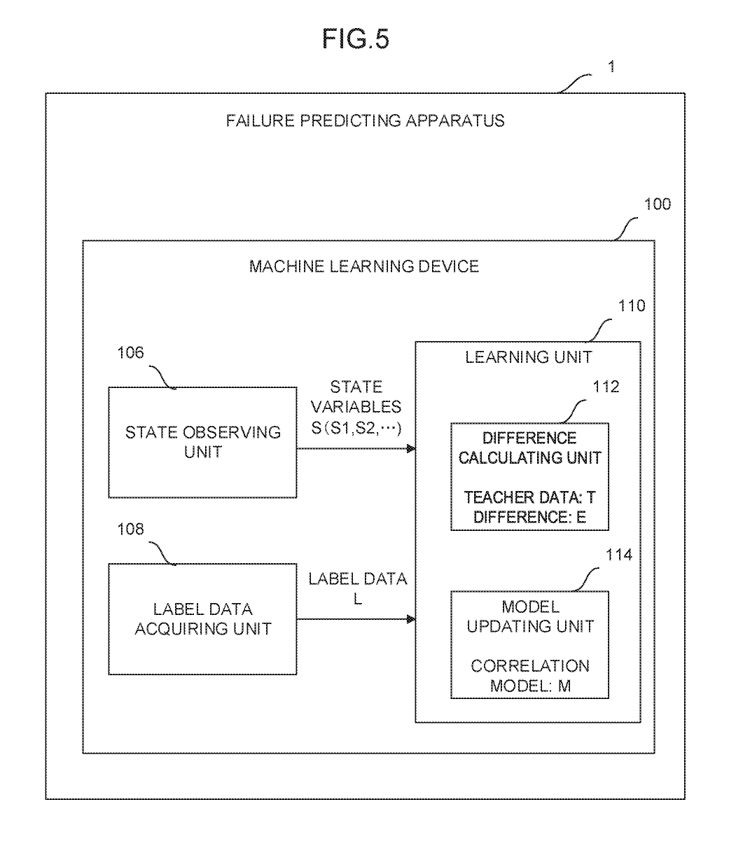

In the machine learning device 100 having the aforementioned configuration, a learning algorithm to be executed by the learning unit 110 is not limited to a particular algorithm, a learning algorithm known as machine learning may be used therefor. FIG. 5 illustrates another embodiment of the failure predicting apparatus 1 illustrated in FIG. 2, and illustrates a configuration including the learning unit 110 that performs supervised learning as another example of the learning algorithm. Supervised learning refers to a learning method in which known data sets (referred to as teacher data sets) each including an input and an output corresponding thereto are given, and a feature implying the correlation between the input and the output is recognized from the teacher data sets, whereby a correlation model for estimating a required output in response to a new input is learned.

In the machine learning device 100 included in the failure predicting apparatus 1 illustrated in FIG. 5, the learning unit 110 includes a difference calculating unit 112 that calculates a difference E, from the state variables S, between a correlation model M for predicting a failure timing of a printed circuit board (and a component) included in the management target device and the correlation feature recognized from teacher data T prepared in advance, and a model updating unit 114 that updates the correlation model M so as to reduce the difference E. By repeated updating of the correlation model M by the model updating unit 114, the learning unit 110 learns the failure timing of the printed circuit board (and the component) included in the management target device with respect to the operating state of the management target device.

The initial value of the correlation model M is expressed by simplifying (for example, by using a linear function of) the correlation between the state variables S and the failure timing of the printed circuit board (and the component) included in the management target device, for example, and is given to the learning unit 110 before start of the supervised learning. The teacher data T may include stored experience values obtained by recording the past operating state of the management target device and the history of maintenance works carried out by a maintenance worker, and is given to the learning unit 110 before start of the supervised learning. The difference calculating unit 112 recognizes, from a large amount of the teacher data T given to the learning unit 110, a correlation feature implying the correlation between the operating state of the management target device and the failure timing of the printed circuit board (and the component) included in the management target device, and obtains the difference E between the correlation feature and the correlation model M corresponding to the state variables S and the label data L in the current state. The model updating unit 114 updates the correlation model M in a direction to reduce the difference E, in accordance with a predetermined updating rule, for example.

In the next learning cycle, a failure timing of a printed circuit board (and a component) included in the management target device is predicted with use of the state variables S in accordance with the updated correlation model M, the difference calculating unit 112 obtains the difference E between the prediction result and the actually acquired label data L, and the model updating unit 114 updates the correlation model M again. In this way, the correlation between an unknown current environmental state and a prediction thereof is gradually revealed.

To proceed with the aforementioned supervised learning, a neural network can be used.

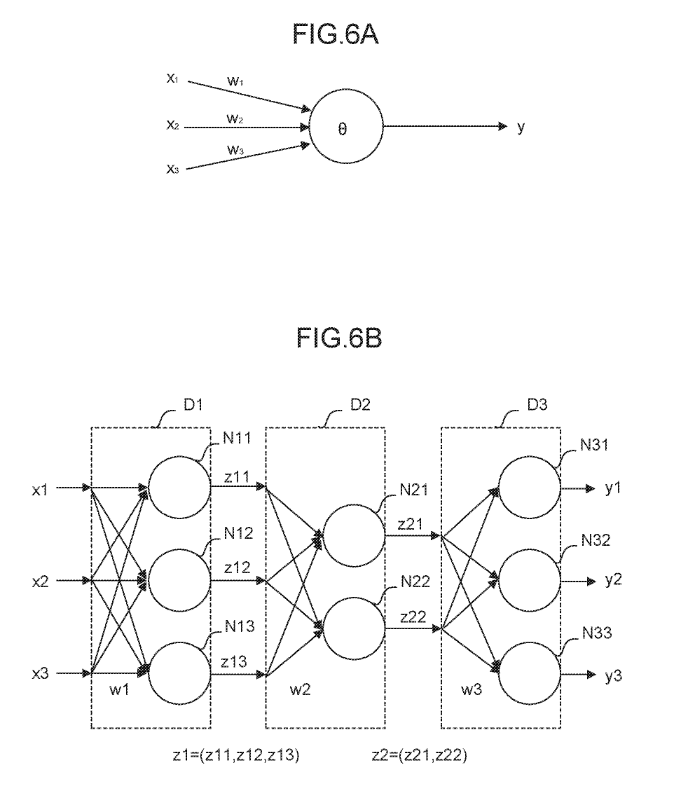

FIG. 6A schematically illustrates a neuron model. FIG. 6B schematically illustrates a model of a three-layer neural network formed by combining the neurons illustrated in FIG. 6A. The neural network may be formed by a computation device or a storage device, etc., simulating the model of neurons, for example.

The neuron illustrated in FIG. 6A outputs a result y in response to a plurality of inputs x (here, inputs x₁ to x₃, as examples). Weights w (w₁ to w₃) corresponding to the inputs x are applied to the x₁ to x₃, respectively. As a result, the neuron outputs the output y expressed by Expression 2 below. In Expression 2, all the inputs x, the output y, and the weights w are vectors. In addition, θ represents a bias and fₖ represents an activation function.

Y=fₖ(Σᵢ₌₁ⁿxᵢwᵢ−θ) [Expression 2]

In the three-layer neural network illustrated in FIG. 6B, a plurality of inputs x (here, inputs x1 to x3 as examples) are inputted from the left side, and results y (here, results y1 to y3, as examples) are outputted from the right side. In the example illustrated in FIG. 6B, the inputs x1, x2, x3 are multiplied by corresponding weights (collectively expressed by w1), and all of the inputs x1, x2, x3 are inputted into each of three neurons N11, N12, N13.

In FIG. 6B, respective outputs from the neurons N11 to N13 are collectively expressed by z1. z1 can be regarded as feature vectors obtained by extracting respective feature amounts of the input vectors. In the example illustrated in FIG. 6B, the feature vectors z1 are multiplied by corresponding weights (collectively expressed by w2) and all the feature vectors z1 are inputted into each of two neurons N21, N22. The feature vectors z1 each represent a feature between the weight w1 and the weight w2.

In FIG. 6B, outputs from the neurons N21, N22 are collectively expressed by z2. z2 can be regarded as feature vectors obtained by extracting the feature amounts of the feature vectors z1. In the example illustrated in FIG. 6B, the feature vectors z2 are multiplied by corresponding weights (collectively expressed by w3), and both the feature vectors z2 are inputted into each of three neurons N31, N32, N33. The feature vectors z2 each represent a feature between the weight w2 and the weight w3. Finally, the neurons N31 to N33 output results y1 to y3, respectively.

Alternatively, a so-called deep learning method using a neural network formed of three or more layers may be used.

In the machine learning device 100 included in the failure predicting apparatus 1, the learning unit 110 executes computing through a multilayer structure according to the aforementioned neural network by using the inputs x as the state variables S, whereby when and in which printed circuit board among the printed circuit boards (and the components) included in the management target device a failure will occur (the results y) can be outputted. The operation modes of the neural network include a learning mode and a value predicting mode. For example, the weights w may be learned by use of a learning data set in the learning mode, and the value of an action may be determined by use of the learned weights w in the value predicting mode. In the value predicting mode, detection, classification, or estimation may be further performed.

The aforementioned configuration of the failure predicting apparatus 1 can be written as a machine learning method (or software) to be executed by the processor 101. This machine learning method is for learning a failure timing of a printed circuit board included in a management target device. The method includes causing a CPU of a computer to execute a step of observing, as the state variables S indicating the current state, the operating state data S1 and the device configuration data S2, a step of acquiring the label data L indicating a result of a maintenance work, and a step of learning, by using the state variables S and the label data L, the operating state data S1, the device configuration data S2, and the failure timing of the printed circuit board included in the management target device such that the operating state data S1 and the device configuration data S2 are associated with the failure timing.

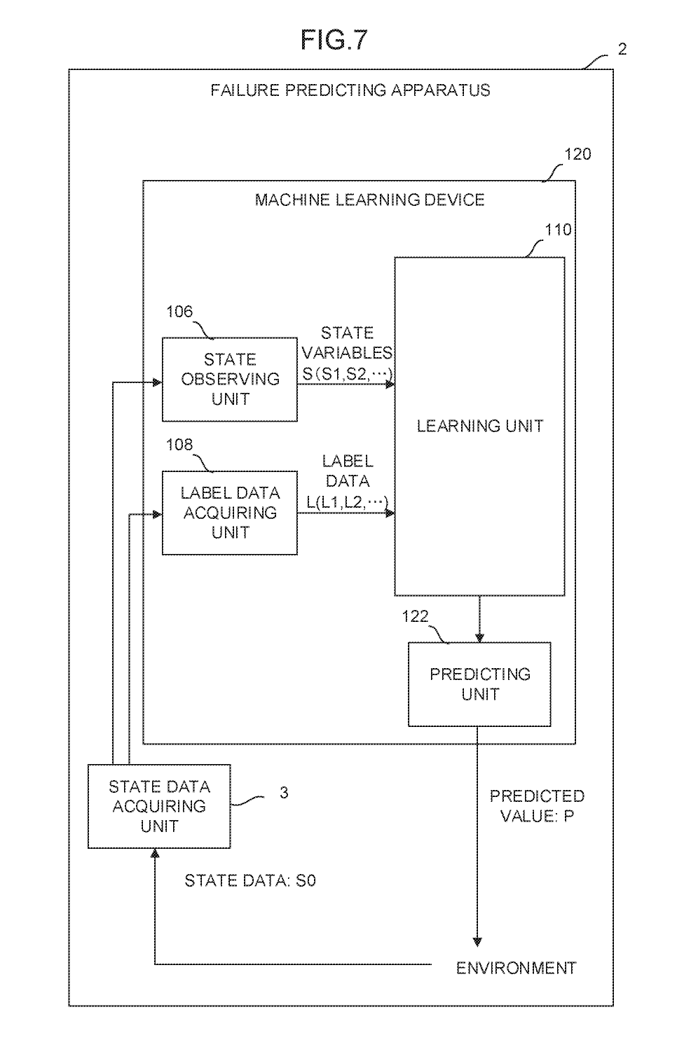

FIG. 7 illustrates a failure predicting apparatus 2 according to a second embodiment. The failure predicting apparatus 2 includes a machine learning device 120 and a state data acquiring unit 3 that acquires, as state data S0, the operating state data S1 and the device configuration data S2 of the state variables S being observed by the state observing unit 106. The state data acquiring unit 3 can acquire the state data S0 from data stored in a memory of the failure predicting apparatus 2, from data inputted from various sensors included in a management target device, or from data inputted, as appropriate, by a maintenance worker, etc.

The machine learning device 120 included in the failure predicting apparatus 2 includes software (e.g., a computational algorithm) and hardware (e.g., the processor 101) for outputting, as a predicted value to the failure predicting apparatus 2, a failure timing of a printed circuit boards included in a management target device obtained by prediction based on a learning result as well as software (e.g., a learning algorithm) and hardware (e.g., the processor 101) for learning, by itself and by machine learning, the failure timing of the printed circuit board included in the management target device. The machine learning device 120 included in the failure predicting apparatus 2 may have a configuration in which one common processor executes software of all algorithms including a learning algorithm, a computational algorithm, and the like.

A predicting unit 122 may be formed as one function of the processor 101, for example. Alternatively, the predicting unit 122 may be formed as software that is for causing the processor 101 to function and that is stored in the ROM 102, for example. The predicting unit 122 generates, in accordance with the result of learning by the learning unit 110, a predicted value P indicating a prediction of a failure timing of a printed circuit board included in the management target device with respect to the operating state of the management target device, and outputs the generated predicted value P.

The machine learning device 120 included in the failure predicting apparatus 2 having the aforementioned configuration provides the same effects as those provided by the aforementioned machine learning device 100. In particular, the machine learning device 120 can give a notification to each management target device or a maintenance worker, etc., by means of outputs from the predicting unit 122 via the failure predicting apparatus 2. On the other hand, in the machine learning device 100, an external device may be required to have a function corresponding to the predicting unit that outputs a prediction based on the result of learning by the learning unit 110.

The embodiments of the present invention have been described above. However, the present invention is not limited to only the aforementioned embodiments, and any appropriate modification may be made to implement various embodiments of the present invention.

For example, a learning algorithm which is executed by the machine learning device 100, 120, a computational algorithm which is executed by the machine learning device 120, a control algorithm which is executed by the failure predicting apparatus 1, 2 are not limited to the aforementioned algorithms, and various algorithms may be used therefor.

Furthermore, in the aforementioned embodiments, the description has been given in which the failure predicting apparatus 1 (or 2) and the machine learning device 100 (or 120) have different CPUs. However, the machine learning device 100 (or 120) may be implemented by the CPU 11 included in the failure predicting apparatus 1 (or 2) and a system program stored in the ROM 12.

Moreover, in the aforementioned embodiments, the example where the machine learning device 120 (or 100) is disposed on the failure predicting apparatus 2 (or 1) has been described. However, the machine learning device 120 (or 100) may be configured to exist in a cloud server, etc. prepared in a network.

The embodiments of the present invention have been described above. However, the present invention is not limited to the above embodiments, and appropriate modifications can be made to carry out the present invention in other embodiments.

1. A failure predicting apparatus for predicting a failure timing of a printed circuit board included in a management target device, the failure predicting apparatus comprising
a machine learning device that learns the failure timing of the printed circuit board included in the management target device with respect to an operating state of the management target device, wherein
the machine learning device includes
a state observing unit that observes, as state variables indicating a current environmental state, operating state data indicating an operating state of the management target device and device configuration data indicating a device configuration of the management target device,
a label data acquiring unit that acquires, as label data, maintenance history data indicating a maintenance history of the management target device, and
a learning unit that, by using the state variables and the label data, learns the failure timing of the printed circuit board included in the management target device, the operating state data, and the device configuration data such that the failure timing is associated with the operating state data and the device configuration data.

2. The failure predicting apparatus according to claim 1, wherein
the operating state data includes at least any one of an accumulated operating time, an accumulated power consumption, an input voltage/current, an output voltage/current, an environmental temperature, an environmental humidity, and a vibration, a usage state of cutting fluid, and a rotation speed of a cooling fan, which are of the management target device.

3. The failure predicting apparatus according to claim 1, wherein
the label data includes failure component information indicating a failure in a component mounted on the printed circuit board, and
the learning unit learns the failure timing of the printed circuit board included in the management target device, a component in which a failure has occurred, the operating state data, and the device configuration data such that the failure timing and the component are associated with the operating state data and the device configuration data.

4. The failure predicting apparatus according to claim 1, wherein
the learning unit includes
a difference calculating unit that calculates a difference between a correlation model for predicting, from the state variables, a failure timing of a printed circuit board included in the management target device and a correlation feature recognizable from teacher data prepared in advance, and
a model updating unit that updates the correlation model so as to reduce the difference.

5. The failure predicting apparatus according to claim 1, wherein
the learning unit computes the state variables and the label data by a multilayer structure.

6. The failure predicting apparatus according to claim 1, further comprising
a predicting unit that outputs a predicted value of a failure timing of a printed circuit board included in the management target device in accordance with a result of learning by the learning unit.

7. The failure predicting apparatus according to claim 1, wherein
the machine learning device exists in a cloud server.

8. A machine learning device for learning a failure timing of a printed circuit board included in a management target device with respect to an operating state of the management target device, the machine learning device comprising
a state observing unit that observes, as state variables indicating a current environmental state, operating state data indicating an operating state of the management target device and device configuration data indicating a device configuration of the management target device,
a label data acquiring unit that acquires, as label data, maintenance history data indicating a maintenance history of the management target device, and
a learning unit that, by using the state variables and the label data, learns the failure timing of the printed circuit board included in the management target device, the operating state data, and the device configuration data such that the failure timing is associated with the operating state data and the device configuration data.
